(19) United States
(12) Patent Application Publication
(10) Pub. No.: US 2008/0170308 A1
(43) Pub. Date: Jul. 17, 2008

(54) Cover for shielding a portion of an arc lamp

(75) Inventors: Marcel Mathijs Theodore Marie Dierichs, Venlo (NL); Henricus Wilhelmus Maria Van Buel, Eindhoven (NL); Rene Alexander Dominicus Toussaint, Hoogeloon (NL); Raoul Maarten Simon Knops, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., Veldhoven (NL)

(21) Appl. No.: 11/652,653

(22) Filed: Jan. 12, 2007

(51) Int. Cl. G02B 5/08

(52) U.S. Cl. 359/838

(57) ABSTRACT

A cover to shield a portion of an arc lamp from electromagnetic radiation is disclosed. The cover has a reflective surface formed from a reflective material suitable to reflect the electromagnetic radiation.

### FIELD

The present invention relates to a cover to shield a portion of an arc lamp, which may for example comprise part of a lithographic apparatus.

### BACKGROUND

A lithographic apparatus is a machine that applies a desired pattern onto a target portion of a substrate. Lithographic apparatus can be used, for example, in the manufacture of integrated circuits (ICs). In that circumstance, a patterning device, which is alternatively referred to as a mask or a reticle, may be used to generate a circuit pattern corresponding to an individual layer of the IC, and this pattern can be imaged onto a target portion (e.g. comprising part of, one or several dies) on a substrate (e.g. a silicon wafer) that has a layer of radiation-sensitive material (resist). In general, a single substrate will contain a network of adjacent target portions that are successively exposed. Known lithographic apparatus include so-called steppers, in which each target portion is irradiated by exposing an entire pattern onto the target portion in one go, and so-called scanners, in which each target portion is irradiated by scanning the pattern through the beam in a given direction (the “scanning”—direction) while synchronously scanning the substrate parallel or anti-parallel to this direction.

Exposure of the pattern is achieved using a radiation source, such as, for example, a Mercury plasma arc lamp. Such a lamp generates radiation by discharging a plasma between two electrodes, i.e. an anode and a cathode. The region between the anode and cathode can be relatively small in size (i.e. approximately 2 to 7 mm).

Typically, the anode and cathode are sealed in an envelope. The envelope is usually made from a material such as quartz. In general, higher quality quartz is used for lamps emitting radiation of shorter wavelengths. The cathode is formed into a small point to ensure a relatively high temperature can be achieved for efficient emission of electrons. Conversely, the anode is larger in size such as to dissipate as much heat as possible, produced by the electron bombardment. For safety reasons, because of the relatively high temperatures produced by such lamps a thermocouple positioned at the anode prevents overheating.

### SUMMARY

In some applications, such as applications for use in a lithographic apparatus, an arc lamp is used in combination with an optical filter and/or reflector suitably disposed to collect and redirect the emitted radiation onto a desired path. In such applications a proportion of the radiation is redirected towards the thermocouple causing the thermocouple, and the environment immediately surrounding the thermocouple, to heat up. Consequently, the thermocouple actuates at a temperature relative to the redirected radiation and not the correct current working temperature of the lamp. The thermocouple therefore has a tendency to deactivate the lamp at a temperature at which it is safely operable. Consequently, this causes the apparatus to suffer from unnecessary periods of inactivity while the lamp is left to cool.

According to an aspect, there is provided a cover to shield a portion of an arc lamp, comprising a reflective surface to prevent, or substantially mitigate, exposure of a portion of the lamp to electromagnetic radiation.

According to an aspect, there is provided a lamp having a cover as described in the preceding paragraph. The cover may be integrally formed with the lamp.

According to an aspect, there is provided a lithographic apparatus comprising an arc lamp, the arc lamp having a cover comprising a reflective surface arranged to shield a portion of the arc lamp to prevent, or substantially mitigate, exposure of a portion of the lamp to electromagnetic radiation.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus according to an embodiment of the invention;

FIG. 2 depicts a known optical source configuration;

FIG. 3 depicts a cover according to an embodiment of the present invention; and

FIG. 4 depicts a lamp according to an embodiment of the present invention.

### DETAILED DESCRIPTION

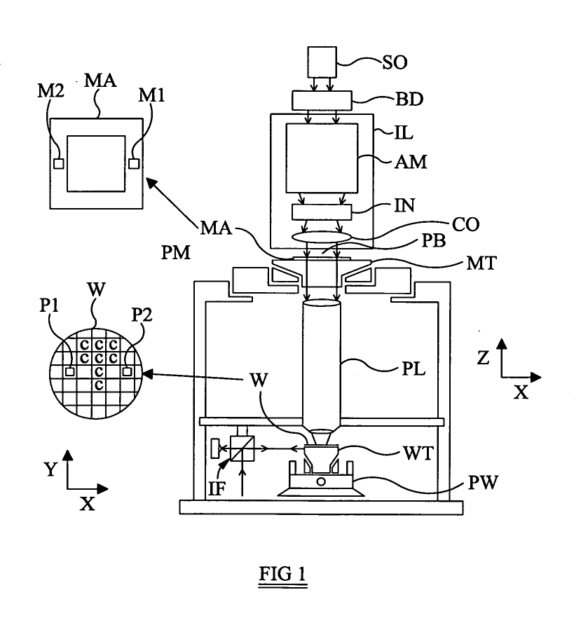

FIG. 1 schematically depicts a lithographic apparatus according to a particular embodiment of the invention. The apparatus comprises:

an illumination system (illuminator) IL to condition a beam PB of radiation

a support structure (e.g. a support structure) MT to support a patterning device (e.g. a mask) MA and connected to first positioning device PM to accurately position the patterning device with respect to item PL;

a substrate table (e.g. a wafer table) WT to hold a substrate (e.g. a resist-coated wafer) W and connected to second positioning device PW to accurately position the substrate with respect to item PL; and

a projection system (e.g. a refractive projection lens) PL configured to image a pattern imparted to the radiation beam PB by patterning device MA onto a target portion C (e.g. comprising one or more dies) of the substrate W.

As here depicted, the apparatus is of a transmissive type (e.g. employing a transmissive mask). Alternatively, the apparatus may be of a reflective type (e.g. employing a programmable mirror array of a type as referred to above).

The term “patterning device” used herein should be broadly interpreted as referring to a device that can be used to impart a radiation beam with a pattern in its cross-section such as to create a pattern in a target portion of the substrate. It should be noted that the pattern imparted to the radiation beam may not exactly correspond to the desired pattern in the target portion of the substrate. Generally, the pattern imparted to the radiation beam will correspond to a particular functional layer in a device being created in the target portion, such as an integrated circuit.

A patterning device may be transmissive or reflective. Examples of patterning device include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned.

The support structure holds the patterning device. It holds the patterning device in a way depending on the orientation of the patterning device, the design of the lithographic apparatus, and other conditions, such as for example whether or not the patterning device is held in a vacuum environment. The support can use mechanical clamping, vacuum, or other clamping techniques, for example electrostatic clamping under vacuum conditions. The support structure may be a frame or a table, for example, which may be fixed or movable as required and which may ensure that the patterning device is at a desired position, for example with respect to the projection system. Any use of the terms “reticle” or “mask” herein may be considered synonymous with the more general term “patterning device”.

The illuminator IL receives a beam of radiation from a radiation source SO. The source and the lithographic apparatus may be separate entities. In such cases, the source is not considered to form part of the lithographic apparatus and the radiation beam is passed from the source SO to the illuminator IL with the aid of a beam delivery system BD comprising for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL may comprise adjusting means AM to adjust the angular intensity distribution of the beam. Generally, at least the outer and/or inner radial extent (commonly referred to as σ-outer and σ-inner, respectively) of the intensity distribution in a pupil plane of the illuminator can be adjusted. In addition, the illuminator IL generally comprises various other components, such as an integrator IN and a condenser CO. The illuminator provides a conditioned beam of radiation PB, having a desired uniformity and intensity distribution in its cross-section.

The illumination system may also encompass various types of optical components, including refractive, reflective, and catadioptric optical components for directing, shaping, or controlling the beam of radiation, and such components may also be referred to below, collectively or singularly, as a “lens”.

The radiation beam PB is incident on the patterning device (e.g. mask) MA, which is held on the support structure MT. Having traversed the patterning device MA, the beam PB passes through the projection system PL, which focuses the beam onto a target portion C of the substrate W. With the aid of the second positioning device PW and position sensor IF (e.g. an interferometric device), the substrate table WT can be moved accurately, e.g. so as to position different target portions C in the path of the beam PB. Similarly, the first positioning device PM and another position sensor (which is not explicitly depicted in FIG. 1) can be used to accurately position the patterning device MA with respect to the path of the beam PB, e.g. after mechanical retrieval from a mask library, or during a scan. In general, movement of the object tables MT and WT will be realized with the aid of a long-stroke module (coarse positioning) and a short-stroke module (fine positioning), which form part of the positioning device PM and PW. However, in the case of a stepper (as opposed to a scanner) the support structure MT may be connected to a short stroke actuator only, or may be fixed. Patterning device MA and substrate W may be aligned using patterning device alignment marks M1, M2 and substrate alignment marks P1, P2.

The term “projection system” used herein should be broadly interpreted as encompassing various types of projection system, including refractive optical systems, reflective optical systems, and catadioptric optical systems, as appropriate for example for the exposure radiation being used, or for other factors such as the use of an immersion fluid or the use of a vacuum. Any use of the term “projection lens” herein may be considered as synonymous with the more general term “projection system”.

The lithographic apparatus may be of a type having two (dual stage) or more substrate tables (and/or two or more support structures). In such “multiple stage” machines the additional tables and/or support structures may be used in parallel, or preparatory steps may be carried out on one or more tables and/or support structure while one or more other tables and/or support structures are being used for exposure.

The lithographic apparatus may also be of a type wherein the substrate is immersed in a liquid having a relatively high refractive index, e.g. water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

The depicted apparatus may be used in one or more of the following modes:

1. In step mode, the support structure MT and the substrate table WT are kept essentially stationary, while an entire pattern imparted to the beam PB is projected onto a target portion C in one go (i.e. a single static exposure). The substrate table WT is then shifted in the X and/or Y direction so that a different target portion C can be exposed. In step mode, the maximum size of the exposure field limits the size of the target portion C imaged in a single static exposure.

2. In scan mode, the support structure MT and the substrate table WT are scanned synchronously while a pattern imparted to the beam PB is projected onto a target portion C (i.e. a single dynamic exposure). The velocity and direction of the substrate table WT relative to the support structure MT is determined by the (de-)magnification and image reversal characteristics of the projection system PL. In scan mode, the maximum size of the exposure field limits the width (in the non-scanning direction) of the target portion in a single dynamic exposure, whereas the length of the scanning motion determines the height (in the scanning direction) of the target portion.

3. In another mode, the support structure MT is kept essentially stationary holding a programmable patterning device, and the substrate table WT is moved or scanned while a pattern imparted to the beam PB is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

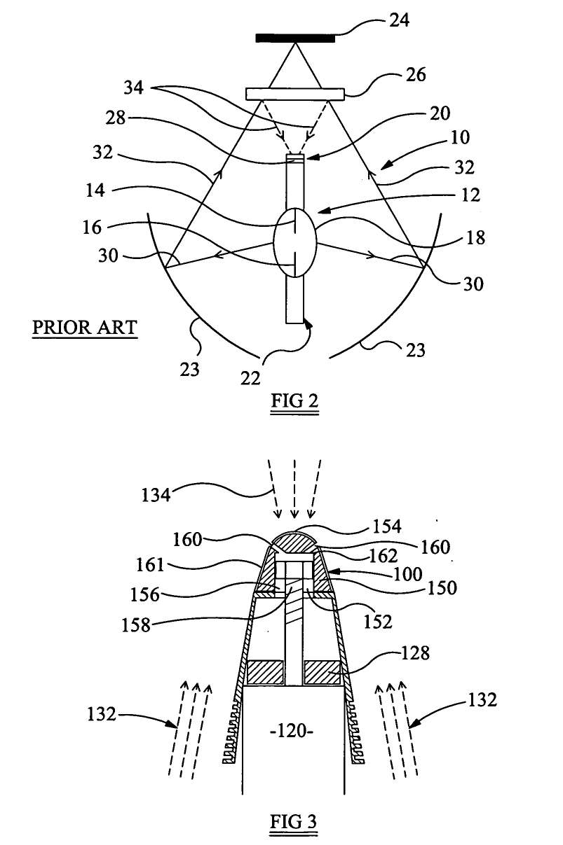

Referring to FIG. 2, a known radiation source 10 (SO in FIG. 1), of an illuminator system forming part of a lithographic apparatus, comprises a plasma arc lamp 12, such as, for example a Mercury plasma arc lamp. The lamp 12 has an anode 14 and a cathode 16, disposed within a quartz envelope 18, and electrical terminals disposed at an anode end 20 and a cathode end 22, of the lamp 12, respectively.

The radiation source further comprises an elliptical mirror 23, disposed around the cathode end 22, and a shutter 24, disposed above the anode end 20. A UV filter 26 is located between the anode end 20, of the lamp, and the shutter 24.

A thermocouple 28 is located in the anode end 20 and is operable to shut down the lamp 12 at temperatures indicative of the region between the anode 14 and the cathode 16 overheating.

In use, radiation is produced by a plasma created in the region between the anode 14 and the cathode 16. The radiation is emitted omni-directionally from the envelope 18. Emitted radiation 30 radiating past the cathode end 22 is collected and reflected by the mirror 23. The elliptical shape of the mirror focuses reflected radiation 32 through the shutter 24, via the UV filter 26. However, in focusing the reflected radiation 32 through the shutter 24, a proportion of the UV component, of the reflected radiation 32, is reflected off the UV filter 26. The reflected UV radiation 34 is incident on the anode end 20 causing the anode end, and the environment immediately surrounding the anode end, to heat up. Furthermore, as it is focused through the environment immediately surrounding the anode end 20, a proportion of the reflected radiation 32 is also incident on the anode end 20 and contributes to raising the temperature of the anode end 20 and the surrounding environment.

Because of the increased temperature of the anode end 20, the thermocouple 28, disposed therein, has a tendency to shut down the lamp 12 at a lower operating temperature than is necessary.

Referring to FIG. 3, a cover 100, according to an embodiment of the present invention, is in the form of a cap 150. Externally, the cap 150 is of a dome (or other) shape and has an open end 152 and a closed end 154. The cap 150 has a hollow 156, which is suitably dimensioned to receive and provide a frictional fit with an anode end terminal 158, which extends from the anode end 120 of the plasma arc lamp. The anode end terminal 158 is generally a hexagonal nut on a screw thread, although it need not be. The cross section of the hollow 156 may be of a hexagonal shape to match the end terminal 158. However, it is desirable for the cross section of the hollow 156 to be of a different shape such as, for example, a square. This provides spaces between portions of the internal surface of the cap 150 and adjacent portions of the external surface of the end terminal 158, which provides ventilation paths therebetween.

Disposed around the periphery of the cap 150, adjacent the closed end 154, are at least two diametrically opposed venting apertures 160, which, in use, provide ventilation from the hollow 156, of the cap 150, to the environment external of the cap 150. However, it will be appreciated that the cap 150 may alternatively comprise different quantities or arrangements of venting apertures 160, or no ventilating apertures, depending on the specific application in which the cap is being used.

The cap 150 is formed from aluminum having a reflective outer surface 161. The cap may alternatively be formed from a different material provided it has a reflective outer surface. For example, the reflective outer surface 161 may be formed from an aluminum coating disposed on a body formed from an alternative material. An anodization coating 162 is disposed on the reflective outer surface 161, which prevents oxidization of the aluminum reflecting surface 161. The anodization coating 162 may be less than 12 μm thick. Alternatively, the anodization coating 162 may be 3 μm, or less. The anodization coating may be formed of SiO₂. However, it will be appreciated that another thickness of anodization coating may be utilized and the anodization coating may be formed from another material having the same effect.

Disposed in the anode end, of a known plasma arc lamp, is a thermocouple 128 to prevent overheating of the anode in the region of the plasma arc, as discussed above in relation to FIG. 1.

In use, as also described above in relation to FIG. 1, reflected radiation 132 and reflected radiation 134 (e.g., reflected UV radiation) are undesirably reflected towards the end terminal 158, of the anode end 120, where the thermocouple 128 is disposed.

The reflective surface 161 acts to reflect the reflected radiation 132 and the reflected radiation 134 off the cap 150 and thereby shields the anode end 120 and the thermocouple 128 therefrom. A broad range of radiation wavelength is reflected and particularly the radiation 132 and reflected radiation 134 having a wavelength less than 400 nm or in a range between 200 nm and 400 nm. The cap 150 therefore prevents or helps mitigate the thermocouple 128 from heating up due to the reflected radiation 132 and the reflected radiation 134, and unnecessarily shutting down the lamp when the operating temperature thereof is normal.

The cap 150 is of a dome shape so as to minimize the reflected radiation 132 and the reflected radiation 134 incident on the surface thereof. Therefore, in use, the dome shape acts to reduce the radiation the reflective surface is required to reflect. Furthermore, the cap 150 being of a dome shape helps avoid undesirably blocking radiation passing the cap 150 and therefore helps maintain maximum transmission of radiation towards the shutter.

Alternatively, or additionally, the cap 150 may be formed having a rim, which, in use, extends radially outward from the anode end terminal 158. The rim is particularly efficient at reflecting the radiation 134 reflected off the UV filter.

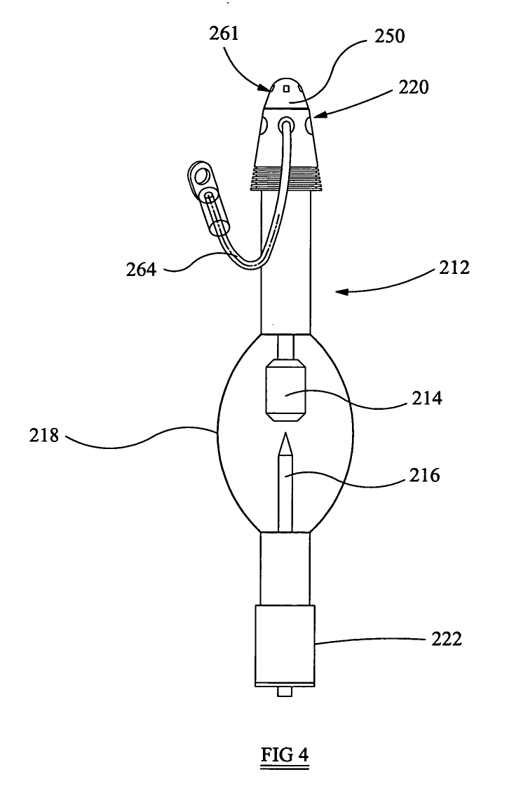

Referring to FIG. 4, an arc lamp 212, according to an embodiment of the present invention, has an anode 214 and a cathode 216, disposed within a quartz envelope 218, and electrical terminals disposed at an anode end 220 and a cathode end 222, of the lamp 212, respectively.

Disposed on the anode end 220 is a cap 250, as described in relation to FIG. 3. The cap 250 may be integrally formed as part of the anode end 220 or, alternatively, may be a component part of the lamp 212. The cap 250 may be replaceable with the lamp 212 or replaceable separately and may be fitted to an existing known lamp.

The lamp 212 further comprises a power cable 264, which is connected to the anode end terminal, referred to above in relation to FIG. 3, to supply electrical power thereto.

As also discussed above in relation to FIG. 3, the cap 250 is operable to reflect reflected radiation from its reflective surface 261 and thereby acts as a shield to help prevent the anode end 220, and the thermocouple disposed therein, from heating up.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion”, respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term. substrate used herein may also refer to a substrate that already contains multiple processed layers.

The terms “radiation” and “beam” used herein encompass all types of electromagnetic radiation, including ultraviolet (UV) radiation (e.g. having a wavelength of 436, 405, 365 or 248 nm).

While specific embodiments of the invention have been described above, it will be appreciated that the invention may be practiced otherwise than as described. The description is not intended to limit the invention.

1. A cover to shield a portion of an arc lamp, comprising a reflective surface to prevent, or substantially mitigate, exposure of a portion of the lamp to electromagnetic radiation.

2. The cover of claim 1, wherein the reflective surface is arranged to reflect radiation having a wavelength less than 420 nm.

3. The cover of claim 1, wherein the cover is in the form of a cap.

4. The cover of claim 1, wherein the reflective surface comprises aluminum.

5. The cover of claim 1, further comprising an anodization coating.

6. The cover of claim 5, wherein the anodization coating is less than 12 μm thick.

7. The cover of claim 6, wherein the anodization coating is 3 μm thick or less.

8. The cover of claim 1, substantially of a dome shape.

9. The cover of claim 1, comprising a venting aperture.

10. An arc lamp comprising a cover to shield a portion of an arc lamp, the cover comprising a reflective surface to prevent, or substantially mitigate, exposure of a portion of the lamp to electromagnetic radiation.

11. The arc lamp of claim 10, wherein the cover is integrally formed therewith.

12. The arc lamp of claim 10, wherein the reflective surface is arranged to reflect radiation having a wavelength less than 420 nm.

13. The arc lamp of claim 10, wherein the cover is in the form of a cap.

14. The arc lamp of claim 10, wherein the reflective surface comprises aluminum.

15. The arc lamp of claim 10, wherein the cover comprises an anodization coating.

16. The arc lamp of claim 15, wherein the anodization coating is less than 12 μm thick.

17. The arc lamp of claim 16, wherein the anodization coating is 3 μm thick or less.

18. The arc lamp of claim 10, wherein the cover is adapted to shield the portion of the lamp in which a thermocouple is disposed.

19. The arc lamp of claim 10, wherein the cover is of a dome shape.

20. The arc lamp of claim 10, wherein the cover comprises a venting aperture.

21. A lithographic apparatus comprising an arc lamp, the arc lamp having a cover comprising a reflective surface arranged to shield a portion of the arc lamp to prevent, or substantially mitigate, exposure of a portion of the lamp to electromagnetic radiation.
